(19) United States
(12) Patent Application Publication
(10) Pub. No.: US 2012/0127142 A1
(43) Pub. Date: May 24, 2012

(54) LIQUID CRYSTAL DISPLAY AND INVERSION DRIVING METHOD

(75) Inventors: Jeong-Geun Yoo, Yongin-city (KR); Seung-Jun Lee, Yongin-city (KR); Sung-Min Kim, Yongin-city (KR)

(73) Assignee: Samsung Mobile Display Co., Ltd., Yongin-city (KR)

(21) Appl. No.: 13/212,943

(22) Filed: Aug. 18, 2011

(30) Foreign Application Priority Data
Nov. 24, 2010 (KR) 10-2010-0117661

(51) Int. Cl. G09G 3/36; G06F 3/038

(52) U.S. Cl. 345/208; 345/94

(57) ABSTRACT

A liquid crystal display (LCD) ensuring excellent display quality and reducing power consumption is disclosed. The liquid crystal display (LCD) includes first and second polarity image display pixels, such that a polarity inversion of data is executed by line, column, and dot, and the polarity inversion of a common voltage is executed by frame. An inversion driving method using the liquid crystal display (LCD) is also disclosed.

### CROSS-REFERENCE TO RELATED APPLICATIONS

This application claims priority to and the benefit of Korean Patent Application No. 10-2010-0117661 filed in the Korean Intellectual Property Office on Nov. 24, 2010, the entire contents of which are incorporated herein by reference.

### BACKGROUND

1. Field

The disclosed technology relates to a liquid crystal display (LCD). More particularly, the present invention relates to a liquid crystal display (LCD) and a driving method thereof having improved display quality and power consumption characteristics.

2. Description of the Related Technology

In general, a liquid crystal display (LCD) displays images using a hold methodology, contrasted with a cathode ray tube that displays images using an impulse methodology. A problem arises with using hold technology in that if the voltage of one polarity is continuously applied to the liquid crystal, the lifetime and performance quality of the liquid crystal is reduced. To prevent this problem, an inversion driving method is widely used in which the polarity of the voltage applied to the liquid crystal is inverted. The inversion driving method has several types: line (column) inversion driving, in which the polarity is inverted by lines (or columns), dot inversion driving, in which the polarity is inverted by pixels, and frame inversion driving, in which the polarity is inverted by frames. The line (column) inversion driving and the dot inversion driving have excellent display quality but the power consumption is large, and the frame inversion driving has low power consumption but the display quality is poor.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One inventive aspect is a liquid crystal display (LCD). The LCD includes one or more first polarity image display pixels, each including a first switching device configured to receive a first data voltage. The first polarity image display pixels also include a first liquid crystal capacitor connected to an output terminal of the first switching device and to a first common electrode configured to receive a first common voltage, and a first sustain capacitor coupled in parallel to the first liquid crystal capacitor and having an electrode connected to the first common electrode. The LCD also includes one or more second polarity image display pixels, each including a second switching device configured to receive a second data voltage, where the polarity the first and second data voltages are opposite. The second polarity image display pixels also include a second liquid crystal capacitor connected to an output terminal of the second switching device and to a second common electrode configured to receive a second common voltage, where the polarity the first and second common voltages are opposite, and a second sustain capacitor coupled in parallel to the second liquid crystal capacitor and having an electrode connected to the second common electrode.

Another inventive aspect is an inversion driving method of a liquid crystal display (LCD). The method includes applying a first data voltage to a first switching device of a first polarity image display pixel including the first switching device, a first liquid crystal capacitor connected to an output terminal of the first switching device and to a first common electrode configured to receive a first common voltage, and a first sustain capacitor coupled in parallel to the first liquid crystal capacitor. The method also includes applying the first common voltage to the first common electrode and to one electrode of the first sustain capacitor, and applying a second data voltage having a polarity opposite the polarity of the first data voltage to a second switching device of a second polarity image display pixel including the second switching device, a second liquid crystal capacitor connected to an output terminal of the second switching device and to a second common electrode configured to receive a second common voltage, and a second sustain capacitor coupled in parallel to the second liquid crystal capacitor. The method also includes applying the second common voltage to the second common electrode and one electrode of the second sustain capacitor, where the second common voltage has a polarity opposite the polarity of the first common voltage.

### BRIEF DESCRIPTION OF THE DRAWINGS

FIG. 1 is a block diagram of a liquid crystal display (LCD) according to exemplary embodiments.

FIG. 2 is a schematic diagram of the first polarity image display group and the second polarity image display group forming a liquid crystal display (LCD) according to an exemplary embodiment, with which a data voltage and a common voltage having opposite polarities is applied when they are in a driving mode.

FIG. 3 is a timing diagram of an N-th pixel that is switched at an N-th horizontal synchronization period and an M-th pixel that is switched at an M-th horizontal synchronization period in the first polarity image display group.

FIG. 4A is a schematic diagram of a liquid crystal panel of a liquid crystal display (LCD) according to the first exemplary embodiment FIG. 4B is a schematic view illustrating an inversion driving method of the liquid crystal display (LCD) of FIG. 4A.

FIG. 5A is a schematic diagram of a liquid crystal panel of a liquid crystal display (LCD) according to the second exemplary embodiment.

FIG. 5B is a schematic view illustrating an inversion driving method of the liquid crystal display (LCD) of FIG. 5A.

FIG. 6A is a schematic diagram of a liquid crystal panel forming a liquid crystal display (LCD) according to the third exemplary embodiment.

FIG. 6B is a schematic view illustrating an inversion driving method of the liquid crystal display (LCD) of FIG. 6A.

### DETAILED DESCRIPTION OF CERTAIN INVENTIVE EMBODIMENTS

Certain advantages and features, and methods of achieving the same, will become apparent and more readily appreciated from the following description of the exemplary embodiments described below in conjunction with the accompanying drawings. However, the present invention is not limited to exemplary embodiments, and may be implemented in various forms. It will be appreciated by those skilled in the art that changes may be made in the disclosed embodiments without departing from the principles and spirit of the general inventive concept. In various exemplary embodiments, certain well-known processes, certain well-known elements, and certain well-known techniques are not explained in detail to avoid ambiguous interpretation. Like reference numerals generally designate like elements throughout the specification.

Throughout this specification and the claims that follow, when it is described that an element is “coupled” to another element, the element may be, for example, “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements. The terms of a singular form may include plural forms unless referred to the contrary.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein

Exemplary embodiments described in this specification are explained with reference to figures generally showing, for example, a layout view, a cross-sectional view, and/or an ideal schematic diagram of the present invention. Accordingly, the exemplary views may be changed by, for example, a manufacturing technique and/or permissible errors. Further, embodiments are not limited by the drawn specific shapes, and include changes of the shapes that are, for example, generated according to a manufacturing process. The exemplary regions in the drawings include schematic properties, and the shapes of the exemplary regions in the drawings generally indicate the specific shapes of the regions of the element.

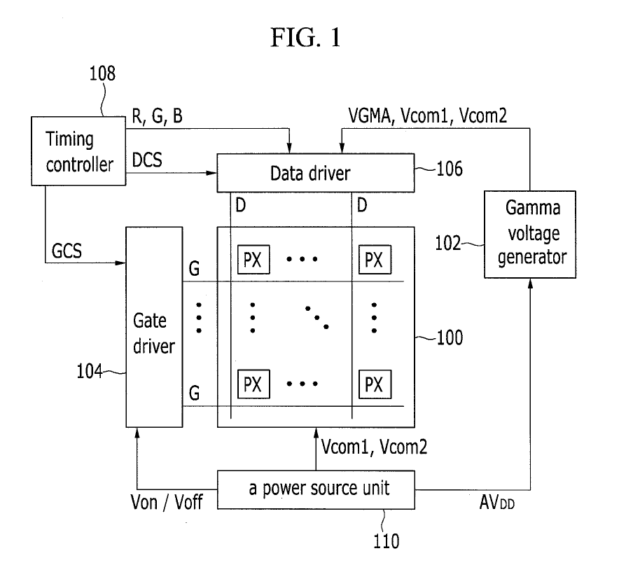

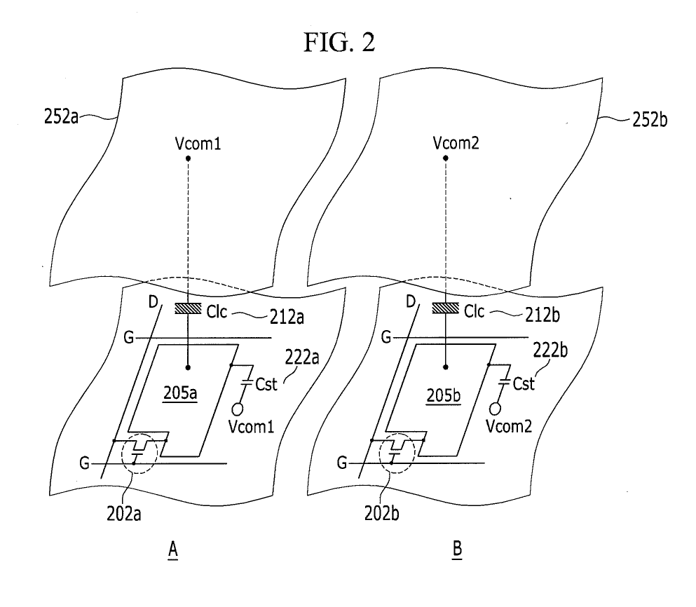

A liquid crystal display (LCD) and an inversion driving method thereof according to certain exemplary embodiments are described with reference to FIG. 1 to FIG. 6B.

FIG. 1 is a block diagram of a liquid crystal display (LCD) according to exemplary embodiments, and FIG. 2 is a schematic diagram of the first polarity image display group and the second polarity image display group forming a liquid crystal display (LCD) according to exemplary embodiments, with which a data voltage and a common voltage having opposite polarities is applied when they are in a driving mode.

Referring to FIG. 1, a liquid crystal display (LCD) according to exemplary embodiments includes a gate driver 104 driving a gate line G of a liquid crystal panel 100, a data driver 106 driving a data line D, a gamma voltage generator 102 generating and supplying a gamma voltage to the data driver 106, a timing controller 108 controlling the data driver 106 and the gate driver 104, and a power source unit 110 generating and supplying a plurality of driving voltages for each circuit block.

The power source unit 110 is supplied with a driving voltage VDD from the outside. The power source unit 110 generates and outputs an analog driving voltage AV_{DD}, common voltages Vcom1 and Vcom2 having opposite polarities, a gate-on voltage V_{ON}, and a gate-off voltage V_{OFF} by using the input driving voltage VDD. The analog driving voltage AV_{DD} is supplied to the gamma voltage generator 102, the gate-on voltage V_{ON} and the gate-off voltage V_{OFF} are supplied to the gate driver 104, and the first and second common voltages Vcom1 and Vcom2 having the opposite polarities are supplied to the liquid crystal panel 100.

The timing controller 108 generates a plurality of control signals DCS and GCS controlling the driving timing of the gate driver 104 and the data driver 106 by using a vertical synchronization signal, a horizontal synchronization signal, a dot clock, and a data enable signal that are input from outside. The data driver 106 selects a gamma voltage according to a digital data signal from the timing controller 108 to supply it to the data line D of the liquid crystal panel 100. Here, the data driver selects a positive polarity gamma voltage or a negative polarity gamma voltage according to polarity control signal for the inversion driving and supplies gamma voltages to the data line.

The gate driver 104 generates the scan signal according to the control signal GCS from the timing controller 108 to supply the scan signal to the gate line G.

The gamma voltage generator 102 generates the reference voltage used for the generation of the gamma voltage and supplies the reference voltage to the data driver 106. In detail, the gamma voltage generator 102 generates a plurality of gamma reference voltages through the analog voltage AV_{DD} input from the power source unit 110, and subdivides them per grayscale to generate gamma voltages VGMA of the positive polarity and the negative polarity and to supply them to the data driver 106.

Referring to FIG. 2, the liquid crystal display (LCD) includes a first polarity image display group A and a second polarity image display group B such that the polarity inversion of the common voltage may be executed by frames while the polarity inversion of the data is executed by lines, by columns, or by pixels. The first polarity image display group A and the second polarity image display group B are applied with data voltages of opposite polarities. Also, the first polarity image display group A and the second polarity image display group B are applied with the common voltages of the opposite polarities.

The first polarity image display group A includes at least one pixel including a first switching device 202a, a first liquid crystal capacitor 212a, a first sustain capacitor 222a, and a first common electrode 252a. The second polarity image display group B includes at least one pixel including a second switching device 202b, a second liquid crystal capacitor 212b, a second sustain capacitor 222b, and a second common electrode 252b. The first and the second switching devices 202a and 202b may be comprise a three terminal device such as a thin film transistor. The first and second switching devices 202a and 202b include a control terminal connected to the gate line G, an input terminal connected to the data line D, and an output terminal respectively connected to the first and second liquid crystal capacitors 212a and 212b and the first and second sustain capacitors 222a and 222b.

The first liquid crystal capacitor 212a has a first pixel electrode 205a and the first common electrode 252a as two electrodes, and the second liquid crystal capacitor 212b has a second pixel electrode 205b and the second common electrode 252b as two electrodes. A liquid crystal layer(not shown) between two electrodes 205a & 252a or 205b & 252b functions as a dielectric material. The first common electrode 252a is applied with the first common voltage Vcom1, and the second common electrode 252b is applied with the second common voltage Vcom2 having opposite polarity as the first common voltage Vcom1.

The first sustain capacitor 222a is coupled in parallel to the first liquid crystal capacitor 212a, and one electrode thereof is applied with the first common voltage Vcom1. The second sustain capacitor 222b is coupled in parallel to the second liquid crystal capacitor 212b, and one electrode thereof is applied with the second common voltage Vcom2. The first and second pixel electrodes 205a and 205b are the other electrodes of the first and second sustain capacitors 222a and 222b, and one electrode is not shown, however the one electrode may be formed with a conductive layer that is additionally formed between the gate line or the first and second pixel electrodes 205a and 205b, and the first and second common electrodes 252a and 252b.

The first and second switching devices 202a and 202b supply the data signal of the data line D to the first and second liquid crystal capacitors 212a and 212b in response to the scan signal of the gate line G. The first liquid crystal capacitor 212a charges the pixel voltage to the difference between the applied first data signal and the first common voltage Vcom1, and the second liquid crystal capacitor 212a charges the pixel voltage to the difference between the second data signal and the second common voltage Vcom2, and the liquid crystal is driven according to the charged pixel voltage to control the light transmittance.

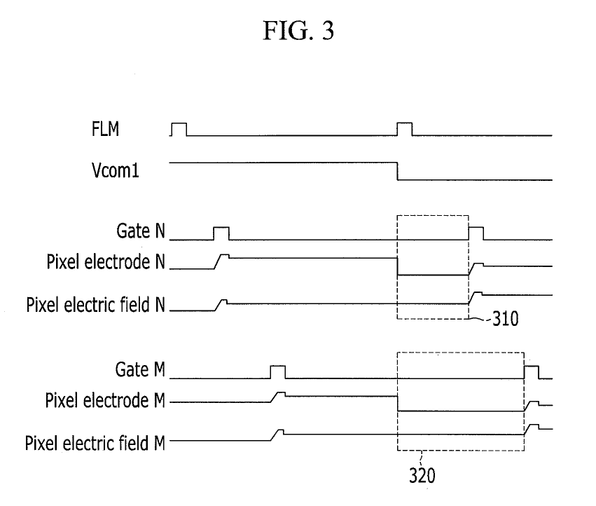

The first and second sustain capacitors 222a and 222b stably maintain the pixel voltage charged to the first and second liquid crystal capacitors 212a and 212b. Particularly, the first and second sustain capacitors 222a and 222b are respectively applied with the same voltage as the first and second common voltages Vcom1 and Vcom2 respectively applied to the first and second common electrode 252a and 252b. Certain benefits of the device will be described with reference to FIG. 3.

FIG. 3 is a timing diagram of an N-th pixel that is switched at an N-th horizontal synchronization period and an M-th pixel switched at an M-th horizontal synchronization period in the first polarity image display group. The first common voltage Vcom1 is inverted by frames according to the frame signal FLM. In contrast, each pixel supplies the first data signal to the first liquid crystal capacitor 212a and the first sustain capacitor 222a according to the scan signal of the gate line G of the first switching device 202a. If the polarity of the first common voltage Vcom1 is inverted according to the next frame signal FLM, the voltage of the first pixel electrode 205a is boosted together therewith. Accordingly, the first common voltage Vcom1 of the inverted polarity is equally applied to one electrode of the first sustain capacitor 222a such that the first pixel electrode 205a is boosted to the same value, as shown in boxes 310 and 320. As a result, the pixel electric field is not changed regardless of the polarity inversion of the first common voltage Vcom1. Accordingly, the pixel electric field is not affected by the boosting. If one electrode of the first sustain capacitor 222a is applied with the different voltage from the first common voltage Vcom1, the boosting of the first pixel electrode 205a is changed, and as a result, the pixel electric field is changed and the image is not properly maintained.

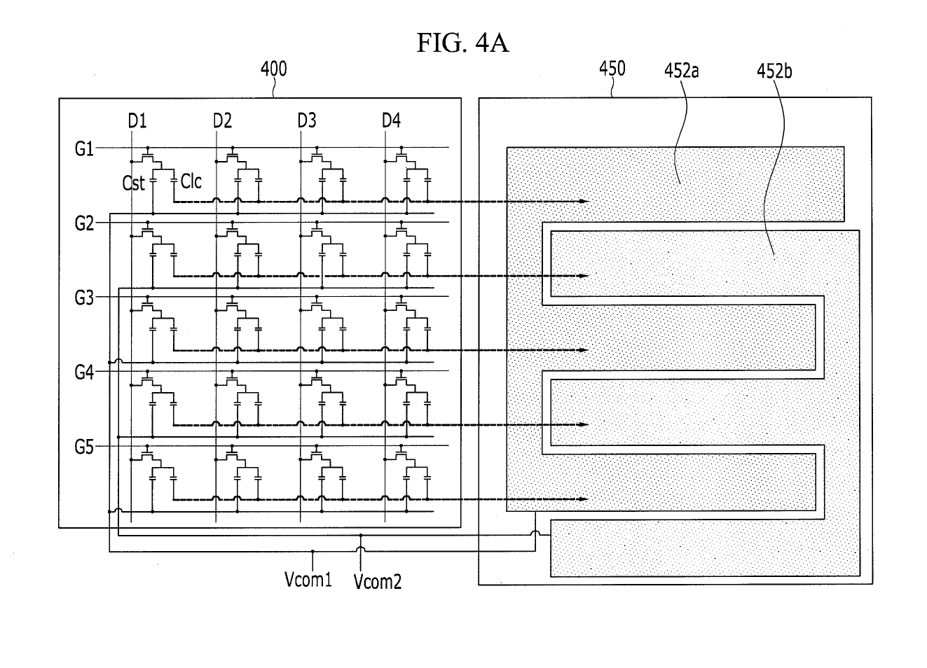

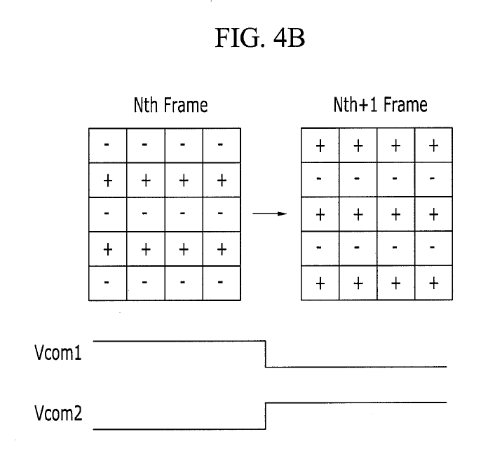

FIG. 4A is a schematic diagram of a liquid crystal panel forming a liquid crystal display (LCD) according to the exemplary embodiment shown in FIG. 2. FIG. 4A is a schematic diagram showing an equivalent circuit of a lower panel 400 of a liquid crystal panel and a layout of a common electrode of an upper panel 450 corresponding to the lower panel 400. FIG. 4B is a schematic view illustrating an inversion driving method of the liquid crystal display (LCD) of FIG. 4A. Five gate lines and four data lines are shown. FIG. 4A and FIG. 4B show the first polarity image display group A and the second polarity image display group B array on the liquid crystal panel.

A first common electrode 452a is patterned to oppose, correspond to, and be parallel to the pixels arranged according to the odd-numbered gate lines G1, G3, and G5 of the lower panel 400, and a second common electrode 452b is patterned to oppose, correspond to, and be parallel to the pixels arranged according to the even-numbered gate lines G2 and G4 of the lower panel 400. In some embodiments, the first common electrode 452a and the second common electrode 452b may be patterned to interleave or otherwise topologically engage with each other with mutual protrusions and depressions. When patterning the first common electrode 452a and the second common electrode 452b to be engaged to each other with protrusions and depressions, a connection structure, for example a conductive dot to apply the first and second common voltages Vcom1 and Vcom2 supplied from the power source unit 110 formed in the lower panel 400 to the first common electrode 452a and the second common electrode 452b may be simply and easily formed. However, this is one example, various modifications from layout and manufacturing processes may be realized by a person of ordinary skill in the art.

Referring to FIG. 4B, in the liquid crystal display (LCD) according to the first exemplary embodiment, the polarity of the pixel is inverted by horizontal lines, and simultaneously the polarity of the pixel is inverted by frames. The inversion of the polarity of the first and second common voltages Vcom1 and Vcom2 is executed with the cycle of the frames.

Accordingly, the liquid crystal display (LCD) according to the first exemplary embodiment is driven by the line inversion method for the switching device driving and the data input such that excellent display quality may be ensured, and the swing of the first and second common voltages Vcom1 and Vcom2 is not necessarily executed with each horizontal period but, instead, with the each frame such that the power consumption of the power source unit 110 is significantly reduced.

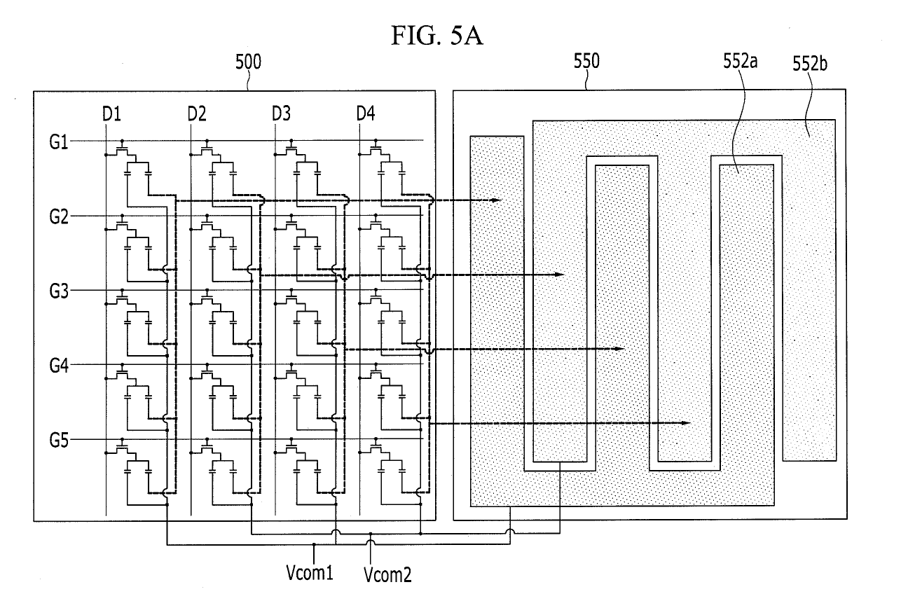

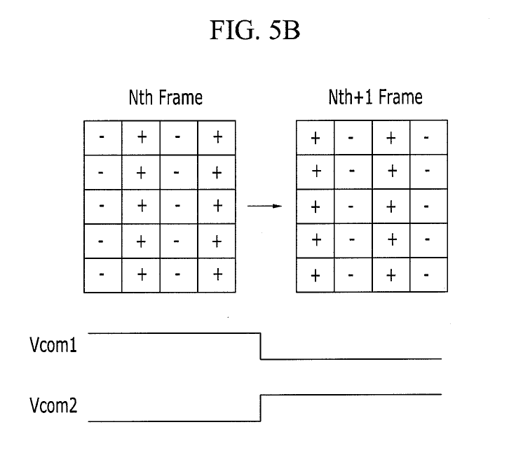

FIG. 5A is a schematic diagram of a liquid crystal panel forming a liquid crystal display (LCD) according to a second exemplary embodiment. In detail, FIG. 5A is a schematic diagram showing an equivalent circuit of a lower panel 500 of a liquid crystal panel and a layout of a common electrode of an upper panel 550 corresponding to the lower panel 500. FIG. 5B is a schematic view to explain an inversion driving method of the liquid crystal display (LCD) of FIG. 5A. FIG. 5A and FIG. 5B show the first polarity image display group A and the second polarity image display group B array on the liquid crystal panel to allow the column inversion.

A first common electrode 552a is patterned to face, to correspond to, and to be parallel with the pixels arranged according to the odd-numbered data lines D1 and D3 of the lower panel 500, and a second common electrode 552b is patterned to face, to correspond to, and to be parallel to the pixels arranged according to the even-numbered data lines D2 and D4 of the lower panel 500. In some embodiments, the first common electrode 452a and the second common electrode 452b may be patterned to be engaged with protrusions and depressions.

Referring to FIG. 5B, in the liquid crystal display (LCD) according to the second exemplary embodiment, the polarity of the pixel is inverted by columns and simultaneously the polarity of the pixel is inverted by frames. Accordingly, the polarities of the first and second common voltages Vcom1 and Vcom2 are not swung with each horizontal period, but with by frames. Accordingly, the liquid crystal display (LCD) according to the second exemplary embodiment is driven with the column inversion method for the switching device driving and the data input such that the excellent display quality may be ensured, and the first and second common voltages Vcom1 and Vcom2 are swung by frames such that the power consumption in the power source unit 110 may be significantly reduced.

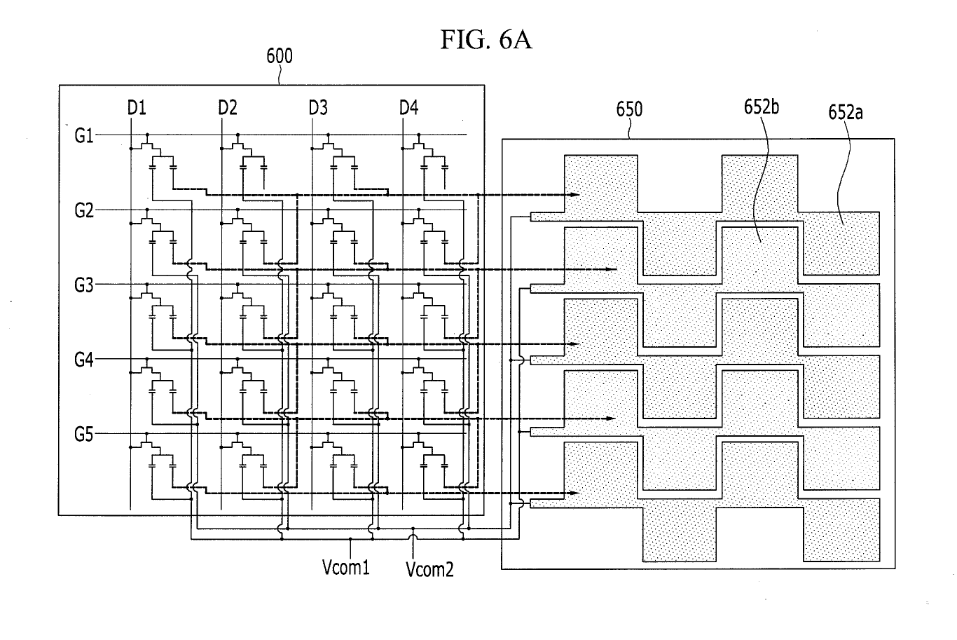

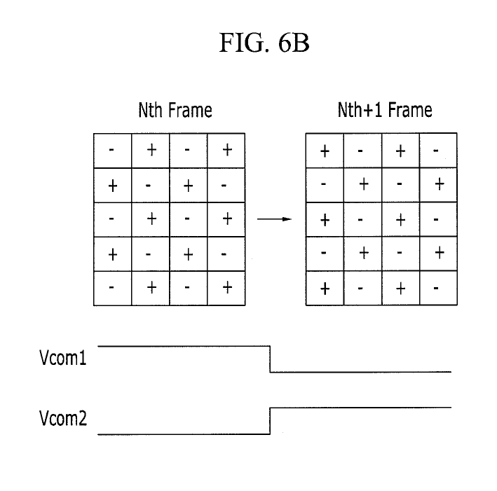

FIG. 6A is a schematic diagram of a liquid crystal panel forming a liquid crystal display (LCD) according to the third exemplary embodiment. FIG. 6A is a schematic diagram showing an equivalent circuit of a lower panel 600 of a liquid crystal panel and a layout of a common electrode of an upper panel 650 corresponding to the lower panel 600. FIG. 6B is a schematic view illustrating an inversion driving method of the liquid crystal display (LCD) of FIG. 6A. FIG. 6A and FIG. 6B show the first polarity image display group A and the second polarity image display group B array on the liquid crystal panel to allow the dot inversion.

A first common electrode 652a is patterned to face the pixels where the odd-numbered gate lines G1, G3, and G5 and the odd-numbered data lines D1 and D3 of the lower panel 600 are intersected and the pixels where the even-numbered gate lines G2 and G4 and the even-numbered data lines D2 and D4 are intersected. The second common electrode 652b is patterned to face the pixels where the even-numbered gate lines G2 and G4 and the odd-numbered data lines D1 and D3 are intersected and the pixels where the odd-numbered gate lines G1 and G3 and the even-numbered data lines D2 and D4 are intersected.

In some embodiments, the first common electrode 652a and the second common electrode 652b may be patterned to be engaged with protrusion and depression shapes. Also, the layout is shown to be inverted with each pixel, however the layout of the first and second common electrodes 652a and 652b may be changed to be inverted with groups of, for example, 1×2, 2×1, 2×2, 3×3, or 4×4 pixels.

Referring to FIG. 6B, in the liquid crystal display (LCD) according to the third exemplary embodiment, the polarity of the pixel is inverted by pixels, and simultaneously the polarity of the pixel is inverted by frames. The polarities of the first and second common voltages Vcom1 and Vcom2 are swung with the cycle of the frame unit.

Accordingly, the liquid crystal display (LCD) according to the third exemplary embodiment is driven with the dot inversion method for the switching device driving and the data input such that excellent display quality may be ensured, and the first and second common voltages Vcom1 and Vcom2 are changed by frame such that the power consumption in the power source unit 110 may be significantly reduced. Also, in conventional dot inversion driving, 2XdV as a data voltage time duration is used, however in the dot inversion driving according to the third exemplary embodiment, a voltage time duration of dV may be used.

The drawings and the detailed description described above are examples are provided to explain various inventive features and aspects. Therefore, it will be appreciated to those skilled in the art that various modifications may be made and other equivalent embodiments are available.

What is claimed is:

1. A liquid crystal display (LCD), comprising:
one or more first polarity image display pixels, each comprising:
a first switching device configured to receive a first data voltage,
a first liquid crystal capacitor connected to an output terminal of the first switching device and to a first common electrode configured to receive a first common voltage, and
a first sustain capacitor coupled in parallel to the first liquid crystal capacitor and having an electrode connected to the first common electrode; and
one or more second polarity image display pixels, each comprising:
a second switching device configured to receive a second data voltage, wherein the polarity the first and second data voltages are opposite,
a second liquid crystal capacitor connected to an output terminal of the second switching device and to a second common electrode configured to receive a second common voltage, wherein the polarity the first and second common voltages are opposite, and
a second sustain capacitor coupled in parallel to the second liquid crystal capacitor and having an electrode connected to the second common electrode.

2. The liquid crystal display (LCD) of claim 1, wherein the polarity of the first and second common voltages is inverted each frame.

3. The liquid crystal display (LCD) of claim 1, wherein the first and second polarity image display pixels are arrayed on a liquid crystal panel and are configured to be driven with line inversion, column inversion, or dot inversion.

4. The liquid crystal display (LCD) of claim 1, wherein the first common electrode and the second common electrode are patterned to be engaged to each other with protrusion and depression shapes.

5. An inversion driving method of a liquid crystal display (LCD), the method comprising:
applying a first data voltage to a first switching device of a first polarity image display pixel comprising the first switching device, a first liquid crystal capacitor connected to an output terminal of the first switching device and to a first common electrode configured to receive a first common voltage, and a first sustain capacitor coupled in parallel to the first liquid crystal capacitor;
applying the first common voltage to the first common electrode and to one electrode of the first sustain capacitor;
applying a second data voltage having a polarity opposite the polarity of the first data voltage to a second switching device of a second polarity image display pixel comprising the second switching device, a second liquid crystal capacitor connected to an output terminal of the second switching device and to a second common electrode configured to receive a second common voltage, and a second sustain capacitor coupled in parallel to the second liquid crystal capacitor; and
applying the second common voltage to the second common electrode and one electrode of the second sustain capacitor, wherein the second common voltage has a polarity opposite the polarity of the first common voltage.

6. The inversion driving method of claim 5, wherein the polarity of the first and second common voltages is inverted each frame.

7. The inversion driving method of claim 5, wherein the first and second polarity image display pixels are arrayed on a liquid crystal panel and are configured to be driven with line inversion, column inversion or dot inversion.

8. The inversion driving method of claim 5, wherein the first common electrode and the second common electrode are patterned to be engaged to each other with protrusion and depression shapes.
